(19) United States
(12) Patent Application Publication
(10) Pub. No.: US 2007/0175020 A1
(43) Pub. Date: Aug. 2, 2007

(54) Method for producing solid state battery

(75) Inventors: Kaoru Nagata, Osaka (JP); Tetsuo Nanno, Osaka (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/656,933

(22) Filed: Jan. 24, 2007

(30) Foreign Application Priority Data
Jan. 27, 2006 (JP) 2006-018812

(51) Int. Cl. H01M 10/04; C04B 35/64

(52) U.S. Cl. 29/623.3; 264/618

(57) ABSTRACT

A method for producing a solid state battery including the steps of: (a) obtaining an active material slurry; (b) obtaining a solid electrolyte slurry; (c) obtaining a current collector slurry; (d) forming an active material green sheet and a solid electrolyte green sheet; (e) laminating the solid electrolyte green sheet on one surface of the active material green sheet to form a first green sheet group, and forming a current collector green sheet layer on the other surface of the active material green sheet to form a second green sheet group; (f) heating the second green sheet group at not less than 200° C. and not greater than 400° C. in an oxidizing atmosphere; and (g) baking the second green sheet group having heated in the step (f) in a low oxygen atmosphere at a baking temperature higher than the heating temperature in the step (f) to obtain a laminate.

### FIELD OF THE INVENTION

The present invention relates to a method for producing a solid state battery comprising a laminate including an active material layer, a solid electrolyte layer and a current collector layer.

### BACKGROUND OF THE INVENTION

As electronic devices become smaller, demand is growing for smaller batteries for use as a power source therefor. In order to achieve miniaturization of batteries, it is necessary to develop batteries having a high energy density. Lithium ion secondary batteries, in particular, are attracting a lot of attention because they have a high voltage and a high energy density.

Lithium ion secondary batteries employ a positive electrode active material such as LiCoO₂ or LiMnO₂ and a negative electrode active material such as a carbon material, a silicon alloy or Li₄Ti₅O₁₂. The electrolyte for lithium ion secondary batteries is usually a solution prepared by dissolving a Li salt in an organic solvent containing a carbonic acid ester and/or an ether.

The electrolyte, however, can leak since it is a liquid. Moreover, because the electrolyte contains an inflammable substance, safety against misuse should be enhanced.

In view of this, development has been underway for solid state batteries having a solid electrolyte. Solid electrolytes, however, have lower conductivity and lower output density than liquid electrolytes as described above.

In order to achieve high energy density, Japanese Laid-Open Patent Publication No. Hei 6-231796 proposes a laminate-type battery comprising a laminate obtained by combining one or more sets each including a positive electrode, a solid electrolyte and a negative electrode. A terminal electrode connected to the positive electrodes and another terminal electrode connected to the negative electrodes are attached to surfaces selected from the side surfaces, the top surface and the bottom surface. The sets each including a positive electrode, a solid electrolyte and a negative electrode are connected either in series or in parallel by the terminal electrodes. The terminal electrodes are formed by a method such as plating, baking, vapor-deposition or sputtering.

In the case of a laminate-type battery comprising a gel electrolyte including a liquid electrolyte, however, such terminal electrodes cannot be formed by any of the above methods. When plating is used, for example, the water contained in the plating solution can enter into the battery. When baking is used, the liquid electrolyte can reach the boiling point and evaporate. When vapor-deposition or sputtering is used, the formation of the terminal electrodes needs to be performed in a reduced pressure atmosphere. In this case also, the liquid electrolyte can reach the boiling point and evaporate.

Perovskite-type Li_{0.33}La_{0.56}TiO₃ and NASICON-type LiTi₂(PO₄)₃ are Li ion conductors capable of transporting Li ions at a high rate. Recently, studies have been carried out on all solid state batteries including such solid electrolyte.

A solid state battery comprising an inorganic solid electrolyte, a positive electrode active material and a negative electrode active material can be produced in the following manner, for example. First, a laminate is formed by laminating a positive electrode active material layer, a solid electrolyte layer and a negative electrode active material layer in this order. The laminate is then sintered by heating so as to obtain a solid state battery. This method bonds the interface between the positive electrode active material layer and the solid electrolyte layer as well as the interface between the solid electrolyte layer and the negative electrode active material layer. This method, however, is disadvantageous for the following reasons.

Journal of Power Sources (vol. 81-82, 1999, p 863-866) reports that when a positive electrode active material LiCoO₂ and a solid electrolyte LiTi₂(PO₄)₃ are sintered, they react to each other during the sintering process, producing compounds that do not take part in the charge/discharge reactions such as CoTiO₃, Co₂TiO₃, Co₂TiO₄ and LiCoPO₄. In other words, substances other than the active material and the solid electrolyte are produced at the interface between the active material layer and the solid electrolyte layer during the sintering process, and therefore the interface between the active material layer and the solid electrolyte layer becomes electrochemically inactive.

In order to solve this problem, Solid State Ionics (vol. 118, 1999, p 149-157) proposes the following method. First, a three-layered pellet comprising LiMn₂O₄ layer, Li_{1.3}Al_{0.3}Ti_{1.7}(PO₄)₃ layer and Li₄Ti₅O₁₂ layer is produced. Then, the three-layered pellet is sintered at 750° C. for 12 hours to obtain an electrode. The electrode is then ground to a thickness of 10 to 100 μm to produce a solid state battery. The three layers each contain LiBO₂—LiF (molar ratio: 44:56) as a sintering agent.

At a low temperature of 750° C., however, the sintering of the three-layered pellet does not proceed sufficiently. Accordingly, the bonding between the solid electrolyte and the active material becomes insufficient. For this reason, the charge/discharge curves shown in Solid State Ionics (vol. 118, 1999, p 149-157) exhibit a very small current value of 10 μA/cm², which indicates that the internal resistance of this solid state battery is very high.

In order to reduce the internal resistance of the solid state battery, the sintering temperature can be increased to facilitate the sintering. According to this method, however, an inactive layer is formed at the interface between the solid electrolyte and the active material due to a reaction between the solid electrolyte and the active material, which inhibits the charge/discharge of the battery.

Further, Japanese Laid-Open Patent Publication No. 2001-210360 proposes to produce a solid state battery by laminating a preform of positive electrode material, a preform of solid electrolyte and a preform of negative electrode material, each preform containing a binder, and then sintering them by means of microwave heating. This patent publication teaches that the preforms can be formed into a sheet, or can be produced by screen-printing a slurry of each raw material onto a base plate, drying it and removing the base plate therefrom.

The patent publication further teaches that the microwave heating can prevent the reaction between the particles contained in the electrode and the particles contained in the solid electrolyte layer, and the filling rate can be improved. However, in the case of the disclosed combinations of the active material and the solid electrolyte, the active material and the solid electrolyte react to each other in a high temperature condition, forming a layer having no lithium ion conductivity at the interface between the active material and the solid electrolyte. It is therefore difficult to prevent the formation of an inactive layer at the interface between the active material and the solid electrolyte even if the microwave heating time is shortened. As discussed above, the method proposed by Japanese Laid-Open Patent Publication No. 2001-210360 cannot prevent the resistance increase at the interface between the active material and the solid electrolyte as well as the capacity reduction due to the degradation of active material.

U.S. Pat. No. 5,597,660 proposes a thin film battery including lithium phosphorus oxynitride (Li_{X}PO_{Y}N_{Z}, where X=2.8 and 3Z+2Y=7.8) as a solid electrolyte.

When a battery is produced by forming a thin film of active material and a thin film of solid electrolyte on a base plate by means of sputtering, the thin films are formed in the state of amorphous. Typically employed active materials such as LiCoO₂, LiNiO₂, LiMn₂O₄ and Li₄Ti₅O₁₂ cannot charge or discharge when they are amorphous. Accordingly, these active materials, when used to produce a thin film battery, need to be crystallized by heating the thin film at about 400 to 700° C.

The lithium phosphorus oxynitride decomposes at about 300° C. It is therefore difficult to crystallize the active material by heating a laminate in which a positive electrode, the solid electrolyte comprising lithium phosphorus oxynitride and a negative electrode are laminated.

In the case of a heat resistant solid electrolyte such as Perovskite-type Li_{0.33}La_{0.56}TiO₃ or NASICON-type LiTi₂(PO₄)₃, when subjected to a heat treatment together with the typically used active material, impurities are produced at the interface between the active material and the solid electrolyte. Accordingly, the obtained battery is difficult to charge/discharge.

As described above, a side reaction that produces substances that do not take part in charge/discharge reactions proceeds at the interface between the active material and the solid electrolyte. As such, it is difficult to form a satisfactory interface between the active material and the solid electrolyte while increasing the densities of the active material layer and the solid electrolyte layer and crystallizing them by means of heating.

There is another way of producing a solid state battery. For example, a solid electrolyte slurry, an active material slurry and a current collector slurry are each prepared by dispersing a solid electrolyte, an active material or a current collector in a solvent containing a binder and a plasticizer. Using the slurries, an active material green sheet, a solid electrolyte green sheet and a current collector green sheet are formed. The obtained green sheets are laminated to form a laminate, which is then sintered.

In this production method, the binder and plasticizer need to be decomposed by heat (removal of binder) at about 300 to 400° C. in the presence of oxygen. When the removal of binder is performed at a high temperature in the presence of oxygen, the metal material contained in the current collector layer such as copper or nickel is oxidized. As a result, the obtained solid state battery has an increased internal resistance.

In view of the above, an object of the present invention is to provide a method for producing an all solid state battery having less internal resistance and a large capacity.

### BRIEF SUMMARY OF THE INVENTION

The present invention relates to a method for producing a solid state battery comprising a laminate including a solid electrolyte layer, an active material layer and a current collector layer, the method comprising the steps of: (a) dispersing an active material powder in a solvent containing a binder and a plasticizer to obtain an active material slurry; (b) dispersing a solid electrolyte powder in a solvent containing a binder and a plasticizer to obtain a solid electrolyte slurry; (c) dispersing a current collector powder in a solvent containing a binder and a plasticizer to obtain a current collector slurry; (d) forming an active material green sheet and a solid electrolyte green sheet using the active material slurry and the solid electrolyte slurry, respectively; (e) laminating the solid electrolyte green sheet on one surface of the active material green sheet to form a first green sheet group, and forming a current collector green sheet layer on the other surface of the active material green sheet using the current collector slurry to form a second green sheet group; (f) heating the second green sheet group at not less than 200° C. and not greater than 400° C. in an oxidizing atmosphere; and (g) baking the second green sheet group having heated in the step (f) in a low oxygen atmosphere at a baking temperature higher than the heating temperature in the step (f) to obtain a laminate including a solid electrolyte layer, an active material layer and a current collector layer.

The baking temperature in the step (g) is preferably not less than 700° C. and not greater than 1000° C.

The current collector powder preferably comprises at least one selected from the group consisting of copper, nickel, palladium, gold and platinum.

In the step (g), an oxygen equilibrium partial pressure (atm) of the low oxygen atmosphere represented by P1 and the baking temperature (° C.) represented by T satisfies −0.0310 T+33.5 [symbol] −log P1 [symbol] −0.0300 T+38.1.

In the step (f), the oxidizing atmosphere preferably contains an oxygen gas, and the oxidizing atmosphere preferably has an oxygen gas equilibrium partial pressure (P2) of not less than 0.1 atm and not greater than 1.0 atm.

Preferably, the step (e) further comprises cutting the first green sheet group or the second green sheet group into a specified size.

The method of the present invention preferably further comprises, after the step (g), forming an external electrode connected to the current collector layer on one surface of the laminate.

The active material powder preferably comprises a first phosphoric acid compound capable of absorbing and releasing lithium ions. The solid electrolyte powder preferably comprises a second phosphoric acid compound having lithium ion conductivity.

The first phosphoric acid compound is preferably represented by the following formula (1):

LiMPO₄ (1)

where M represents at least one selected from the group consisting of Mn, Fe, Co and Ni.

The second phosphoric acid compound is preferably represented by the following formula (2):

Li_{1+X}M^{III}_{X}Ti^{IV}_{2-X}(P₄)₃ (2)

where M^{III} represents at least one selected from the group consisting of Al, Y, Ga, In and La, and 0 [symbol] X [symbol] 0.6.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1 is a schematic diagram showing a vertical cross section of a solid electrolyte green sheet formed on a carrier film.

FIG. 2 is a schematic diagram showing a vertical cross section of an active material green sheet formed on a carrier film.

FIG. 3 is a schematic diagram showing a vertical cross section of a solid electrolyte green sheet and a carrier film attached onto a substrate having a polyester film.

FIG. 4 is a schematic diagram showing how the carrier film is peeled off from the solid electrolyte green sheet attached onto the substrate.

FIG. 5 is a schematic diagram showing a vertical cross section of 20 solid electrolyte green sheets and one active material green sheet attached onto a substrate having a polyester film.

FIG. 6 is a schematic diagram showing a vertical cross section of a second green sheet group sandwiched between ceramic plates.

FIG. 7 is a schematic diagram showing a vertical cross section of a coin type battery produced in EXAMPLEs of the present invention.

FIG. 8 shows X-ray diffraction patterns of a second green sheet group produced in EXAMPLE 1 before and after the heat treatment in the fourth step.

### DETAILED DESCRIPTION OF THE INVENTION

The present invention provides a method for producing a solid state battery comprising a laminate including a solid electrolyte layer, an active material layer and a current collector layer, the method comprising the steps of: (a) dispersing an active material powder in a solvent containing a binder and a plasticizer to obtain an active material slurry; (b) dispersing a solid electrolyte powder in a solvent containing a binder and a plasticizer to obtain a solid electrolyte slurry; (c) dispersing a current collector powder in a solvent containing a binder and a plasticizer to obtain a current collector slurry; (d) forming an active material green sheet and a solid electrolyte green sheet using the active material slurry and the solid electrolyte slurry, respectively; (e) laminating the solid electrolyte green sheet on one surface of the active material green sheet to form a first green sheet group, and forming a current collector green sheet layer on the other surface of the active material green sheet using the current collector slurry to form a second green sheet group; (f) heating the second green sheet group at not less than 200° C. and not greater than 400° C. in an oxidizing atmosphere; and (g) baking the second green sheet group having heated in the step (f) in a low oxygen atmosphere at a baking temperature higher than the heating temperature in the step (f) to obtain a laminate including a solid electrolyte layer, an active material layer and a current collector layer.

### (1) First Step (Preparation of Slurries)

In the step (a), an active material slurry is prepared by dispersing an active material powder in a solvent containing a binder and a plasticizer. The active material powder preferably has an average particle size of 0.1 to 10 μm, and more preferably 0.5 to 5 μm. The amount of the binder contained in the active material slurry is, for example, 5 to 30 parts by weight per 100 parts by weight of the active material powder. The amount of the plasticizer is, for example, 1 to 20 parts by weight per 100 parts by weight of the active material powder.

In the step (b), a solid electrolyte slurry is prepared by dispersing a solid electrolyte powder in a solvent containing a binder and a plasticizer. The solid electrolyte powder preferably has an average particle size of 0.1 to 10 μm, and more preferably 0.5 to 5 μm. The amount of the binder contained in the solid electrolyte slurry is, for example, 5 to 30 parts by weight per 100 parts by weight of the solid electrolyte powder. The amount of the plasticizer is, for example, 1 to 20 parts by weight per 100 parts by weight of the solid electrolyte powder.

The active material powder preferably comprises a first phosphoric acid compound capable of absorbing and releasing lithium ions. The solid electrolyte powder preferably comprises a second phosphoric acid compound having lithium ion conductivity. The first phosphoric acid compound and the second phosphoric acid compound should be different phosphoric acid compounds.

The first phosphoric acid compound is preferably represented by the following formula (1):

LiMPO₄ (1)

where M represents at least one selected from the group consisting of Mn, Fe, Co and Ni.

Among compounds represented by the formula (1), LiCoPO₄ is particularly preferred.

The second phosphoric acid compound is preferably represented by the following formula (2):

Li_{1+X}M^{III}_{X}Ti^{IV}_{2-X}(PO₄)₃ (2)

where M^{III} represents at least one selected from the group consisting of Al, Y, Ga, In and La, and 0 [symbol] X [symbol] 0.6.

Among compounds represented by the formula (2), Li_{1.3}Al_{0.3}Ti_{1.7}(PO₄)₃ is particularly preferred.

By using the first phosphoric acid compound as an active material and the second phosphoric acid compound as a solid electrolyte, the active material layer and the solid electrolyte layer can be sintered without producing an inactive layer at the interface therebetween.

In the step (c), a current collector slurry is prepared by dispersing a current collector powder in a solvent containing a binder and a plasticizer. The current collector powder preferably has an average particle size of 0.1 to 10 μm, and more preferably 0.5 to 5 μm. The amount of the binder contained in the current collector slurry is, for example, 5 to 30 parts by weight per 100 parts by weight of the current collector powder. The amount of the plasticizer is, for example, 1 to 20 parts by weight per 100 parts by weight of the current collector powder.

The current collector powder comprises an electron conductive metal material. The current collector powder preferably comprises at least one metal material selected from the group consisting of copper, nickel, palladium, gold and platinum.

The current collector slurry may further comprise a heat adhesive glass frit. In this case, the glass frit preferably has a low softening point of about 400 to 700° C. The amount of the glass frit is preferably 0.5 to 15 parts by weight per 100 parts by weight of the current collector powder.

The binder and plasticizer may be dispersed or dissolved in a solvent. The binder can be, for example, a polyvinylbutyral resin, methyl cellulose, polyvinyl alcohol, ethyl cellulose or cellulose acetate.

The plasticizer can be, for example, dibutyl phthalate, polyacrylate, polyvinyl acetate or cellulose acetate. The addition of the plasticizer to a green sheet imparts flexibility and elasticity to the green sheet.

The solvent can be, for example, an alcohol such as ethanol, n-butyl acetate or ethyl acetate. Particularly preferred is n-butyl acetate or ethyl acetate.

### (2) Second Step (Formation of Green Sheets)

In the second step (i.e., step (d)), an active material green sheet and a solid electrolyte green sheet are formed using the active material slurry and the solid electrolyte slurry, respectively. The green sheets can be formed as follows, for example.

The active material slurry is applied onto a substrate having a release agent layer on its surface. The applied active material slurry is then dried to obtain an active material green sheet. Likewise, using the solid electrolyte slurry, a solid electrolyte green sheet can be obtained in the same manner as above.

The substrate can be a polyethylene sheet or a polyethylene film.

The method for applying the slurries is not limited to particular methods as long as a thin active material green sheet and a thin solid electrolyte green sheet can be obtained. For example, doctor blade method can be used.

### (3) Third Step (Production of Green Sheet Group)

In the third step (i.e., step (e)), a green sheet group including an active material green sheet, a solid electrolyte green sheet and a current collector green sheet is produced. The green sheet group can be produced as follows, for example.

First, the active material green sheet and the solid electrolyte green sheet are laminated to form a first green sheet group. For the formation of the first green sheet group, only one active material green sheet may be used, or a plurality of active material green sheets may be laminated successively. Likewise, only one solid electrolyte green sheet may be used, or a plurality of solid electrolyte green sheets may be laminated successively.

Subsequently, onto the first green sheet group including the active material green sheet and the solid electrolyte green sheet is formed a current collector green sheet layer using the current collector slurry so as to obtain a second green sheet group. The second green sheet may comprise a plurality of first green sheet groups laminated with the current green sheet layer between every adjacent first green sheet groups. In this case, the first green sheet groups should be laminated such that the active material layers of the same polarity face to each other with the current collector green sheet layer therebetween.

The current collector green sheet layer can be formed by, for example, applying the current collector slurry directly onto a surface of the active material green sheet opposite to the surface thereof in contact with the solid electrolyte green sheet. Alternatively, the current collector green sheet may be formed, using the current collector slurry, in the same manner as the active material green sheet and the solid electrolyte green sheet are formed. The obtained current collector green sheet is then laminated onto a surface of the active material green sheet opposite to the surface thereof in contact with the solid electrolyte green sheet so as to form a current collector green sheet layer.

### (4) Fourth Step (Heating Step)

In the fourth step (i.e., step (f)), the second green sheet group including the active material green sheet, the solid electrolyte green sheet and the current collector green sheet layer is heated at not less than 200° C. and not greater than 400° C. in an oxidizing atmosphere to remove the binder and the plasticizer (low temperature heating). During this fourth step, the binder and plasticizer contained in the active material green sheet, the solid electrolyte green sheet and the current collector green sheet layer are decomposed into a gas which is released from the second green sheet group. In other words, organic matter is removed from the second green sheet group. Moreover, because the temperature for the heating step (heating temperature) is set to not less than 200° C. and not greater than 400° C., the current collector can be protected from oxidation. The heating temperature is preferably not less than 280° C. and not greater than 380° C.

The oxidizing atmosphere may be composed of, for example, an oxygen gas or air.

In the fourth step, when the oxidizing atmosphere is composed of an oxygen gas, the oxidizing atmosphere preferably has an oxygen gas equilibrium partial pressure (P2) of not less than 0.1 atm and not greater than 1.0 atm (1 atm=1.013×10⁵ Pa). When the oxygen gas equilibrium partial pressure (P2) is not less than 0.1 atm, the binder and plasticizer can be protected from carbonization. This further facilitates the removal of organic matter (i.e., binder and plasticizer) from the active material green sheet, the solid electrolyte green sheet and the current collector green sheet layer. That is, each layer of the laminate is not hindered from sintering and increasing density. Further, the self-discharge and internal short-circuit resulting from the conductivity of carbons generated by the carbonization does not occur easily. On the other hand, when the oxygen gas equilibrium partial pressure (P2) is not greater than 1.0 atm, the oxidation of the active material and the solid electrolyte can be prevented. In this case, the oxidizing atmosphere preferably contains an inactive gas in addition to the oxygen gas. The inert gas can be, for example, a nitrogen gas or argon gas.

### (5) Fifth Step (Baking Step)

In the fifth step (i.e., step (g)), the second green sheet group having heated in the fourth step is baked in a low oxygen atmosphere at a baking temperature higher than the heating temperature in the forth step (high temperature baking). Although the metal material contained in the current collector layer is sometimes partially oxidized during the fourth step, the oxidized metal material can be reduced by baking the second green sheet group having heated in the fourth step in a low oxygen atmosphere. Because the oxidation of the current collector layer is prevented by this step, a solid state battery having a reduced internal resistance can be obtained.

Preferably, the fourth step and the fifth step are performed successively.

The baking temperature in the fifth step is preferably not less than 700° C. and not greater than 1000° C., and more preferably 850 to 950° C. When the baking temperature is not less than 700° C., the baking proceeds sufficiently, and the densities of the layers included in the laminate can be increased. When the baking temperature is not greater than 1000° C., the interdiffusion of the elements contained in the active material layer and the solid electrolyte layer at the interface therebetween can be prevented. Accordingly, the composition of the active material and that of the solid electrolyte can be retained, whereby a solid state battery having excellent electrochemical characteristics can be obtained.

In the fifth step, an oxygen equilibrium partial pressure (atm) of the low oxygen atmosphere represented by P1 and the baking temperature (° C.) represented by T preferably satisfies

−0.0310 T+33.5 [symbol] −log P1 [symbol] −0.0300 T+38.1 (3).

When the oxygen equilibrium partial pressure P1 is high, the current collector may be oxidized, or the current collector layer oxidized in the fourth step may not be reduced. When the oxygen equilibrium partial pressure P1 is lower than the above range, the production of carbons may not be prevented in the current collector layer, the solid electrolyte layer, and the active material layer.

In order to constantly adjust the oxygen equilibrium partial pressure P1 to fall in the above range, the low oxygen atmosphere preferably comprises a mixed gas comprising at least a gas capable of releasing oxygen gas (e.g., carbon dioxide gas) and a gas capable of reacting with oxygen gas (e.g., hydrogen gas). An example of the mixed gas is a mixed gas comprising a carbon dioxide gas, a hydrogen gas and a nitrogen gas. When the mixed gas contains a hydrogen gas, for safety reasons, the amount of hydrogen gas in the mixed gas is preferably set to less than 4 vol % which is the explosion limit concentration of hydrogen gas. The amount of carbon dioxide gas is preferably 1 to 99 vol % of the mixed gas.

In the mixed gas comprising a carbon dioxide gas, a hydrogen gas and a nitrogen gas, the reaction as represented by the following formulas (4) and (5) occurs:

CO₂→CO+½O₂ (4)

H₂+½O₂→H₂O (5)

The reaction represented by the formula (4) produces oxygen gas, and the reaction represented by the formula (5) consumes the oxygen gas. As such, oxygen gas exists in the atmosphere gas, and at the same time, the partial pressure of the oxygen gas is maintained at an almost constant level.

The filling rates of the active material layer, the solid electrolyte layer and the current collector layer can be controlled by adjusting, for example, the baking temperature and the increasing rate of the baking temperature in the fifth step. The increasing rate of the baking temperature in the fifth step is preferably not less than 500° C./h, and more preferably not less than 900° C./h.

After the baking step, an external electrode connected to the current collector layer may be formed on one surface of the laminate.

In the baked laminate, cracking is likely to occur when the laminate is cut. For this reason, the step of producing a green sheet group (i.e., the third step) preferably comprises cutting the first green sheet group or the second green sheet group into a specified size.

The active material layer included in the laminate produced by the above production method functions as a positive electrode active material layer in a solid state battery.

The negative electrode active material can be metal lithium. When metal lithium comes in contact with the solid electrolyte layer, however, the solid electrolyte may be reduced. To avoid this, a Li ion conductive layer is preferably disposed between the metal lithium and the solid electrolyte layer. The Li ion conductive layer can be, for example, a PEO-LiTFSI layer comprising polyethylene oxide (PEO) and LiN(SO₂CF₃)₂ (LiTFSI). PEO and LiTFSI are preferably mixed such that the molar ratio of the oxygen atoms of PEO to the lithium atoms of LiTFSI ([O]/[Li]) is 10:1 to 30:1. The Li ion conductive layer preferably has a thickness of 1 to 10 μm.

### EXAMPLE 1

The present invention will be described below with reference to examples. It should be understood, however, that the scope of the present invention is not limited thereto.

A battery was produced in the following procedure.

### (1) First Step

LiCoPO₄ having an average particle size of 1 μm was used as a positive electrode active material powder. The active material powder in an amount of 100 parts by weight was mixed with 15 parts by weight of polyvinylbutyral resin serving as a binder (S-Lec BM-S available from Sekisui Chemical Co., Ltd.), 7 parts by weight of dibutyl phthalate serving as a plasticizer and 130 parts by weight of n-butyl acetate serving as a solvent (available from Kanto Chemical Co. Inc.). The mixture was then mixed using zirconia balls in a ball mill for 24 hours to obtain an active material slurry.

Li_{1.3}Al_{0.3}Ti_{1.7}(PO₄)₃ having an average particle size of 1 μm was used as a solid electrolyte powder. The solid electrolyte powder in an amount of 100 parts by weight was mixed with 15 parts by weight of polyvinylbutyral resin serving as a binder, 7 parts by weight of dibutyl phthalate serving as a plasticizer and 130 parts by weight of n-butyl acetate serving as a solvent. The mixture was then mixed using zirconia balls in a ball mill for 24 hours to obtain a solid electrolyte slurry.

A copper powder having an average particle size of 1 μm was used as a current collector powder. The current collector powder in an amount of 100 parts by weight was mixed with 15 parts by weight of polyvinylbutyral resin serving as a binder, 7 parts by weight of dibutyl phthalate serving as a plasticizer and 130 parts by weight of n-butyl acetate serving as a solvent. The mixture was then mixed using zirconia balls in a ball mill for 24 hours to obtain a current collector slurry.

### (2) Second Step

The solid electrolyte slurry was applied onto a carrier film 1 composed mainly of polyester resin using a doctor blade. The applied slurry was then dried at 150° C. for 30 minutes, whereby a solid electrolyte green sheet 3 (thickness: 25 μm) as shown in FIG. 1 was formed. The carrier film 1 had a release agent layer formed on the surface thereof.

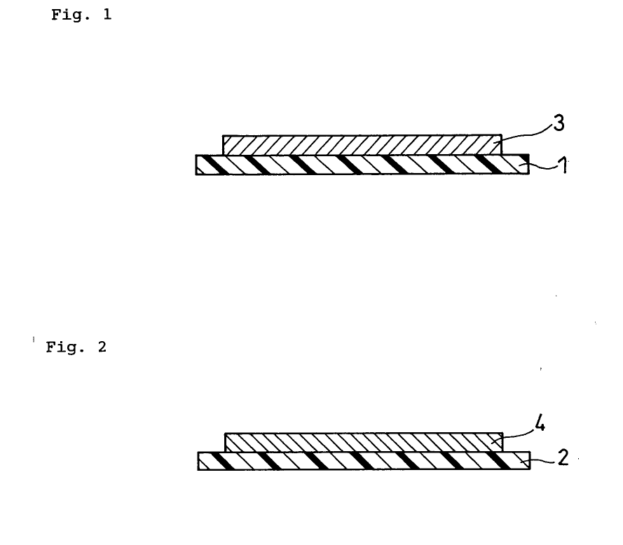

Similarly, a positive electrode active material green sheet 4 (thickness: 4 μm) as shown in FIG. 2 was formed on a carrier film 2 using the positive electrode active material slurry prepared above.

### (3) Third Step

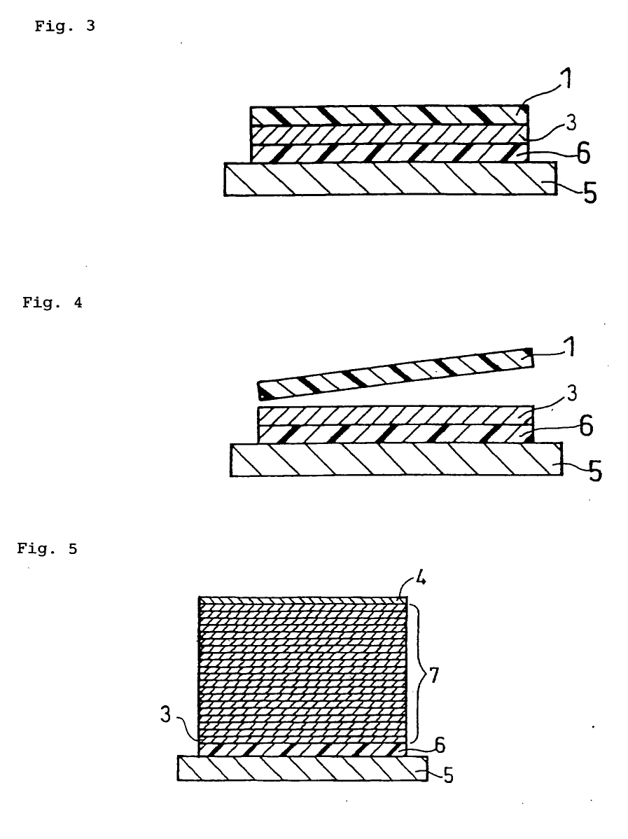

As shown in FIG. 3, a polyester film 6 having adhesive layers (not shown) on both surfaces thereof was placed on one surface of a stainless steel substrate 5. On the other surface of the polyester film 6 was placed the solid electrolyte green sheet 3 such that the surface of the green sheet 3 not having the carrier film 1 was in contact with the other surface of the polyester film 6.

At a temperature of 80° C., a pressure of 100 kg/cm² was applied onto the carrier film 1. Thereafter, the carrier film 1 was peeled off from the solid electrolyte green sheet 3 as shown in FIG. 4.

On this solid electrolyte green sheet 3 was placed another solid electrolyte green sheet 3′ formed on a carrier film 1′ produced in the same manner as the solid electrolyte green sheet 3 was formed. Similar to the above, the same pressure was applied onto the carrier film 1′ at the same temperature so as to bond the solid electrolyte green sheet 3 and the solid electrolyte green sheet 3′. The carrier film 1′ was then peeled off from the solid electrolyte green sheet 3′. This process was repeated 20 times to produce a solid electrolyte green sheet group 7.

On the solid electrolyte green sheet group 7 was placed the positive electrode active material green sheet 4. Similar to the above, the same pressure was applied onto the carrier film 2 at the same temperature so as to bond the solid electrolyte green sheet group 7 and the positive electrode active material green sheet 4. The carrier film 2 was then peeled off from the positive electrode active material green sheet 4. Thereby, a first green sheet group 8 as shown in FIG. 5 was obtained.

The first green sheet group 8 was peeled off from the polyester film 6, which was then cut into a piece having an area of 7 μm×7 mm. Thereby, a green chip was obtained. The current collector slurry was applied onto the positive electrode active material green sheet of the green chip, which was then dried at 150° C. for 30 minutes to form a current collector green sheet layer 9. Thereby, a second green sheet group 10 was obtained.

### (4) Fourth Step

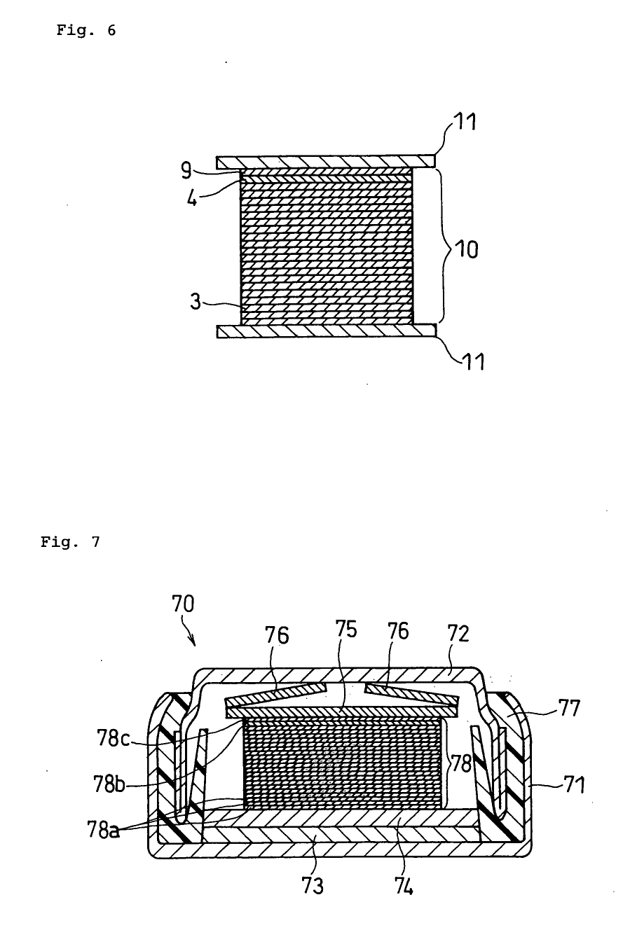

As shown in FIG. 6, the second green sheet group 10 was sandwiched by two ceramic plates 11 made of alumina.

The second green sheet group 10 sandwiched between the ceramic plates 11 was heated to 350° C. in the air (equilibrium partial pressure of oxygen gas (P2): 0.2 atm) with an increasing temperature rate of 400° C./h. The temperature was then held at 350° C. for 5 hours to cause thermal decomposition of organic matter (i.e., binder and plasticizer).

### (5) Fifth Step

The second green sheet group 10 heated in the fourth step was heated to 900° C. in a reduced gas containing CO₂, H₂ and N₂ at a volume ratio of 4.99/0.01/95 with an increasing temperature rate of 1000° C./h, and then cooled with an decreasing temperature rate of 1000° C./h (the baking temperature T was 900° C.). The oxygen equilibrium partial pressure (P1) was 10⁻¹¹ atm. That is, −log P1 equals 11, so −0.0310 T+33.5 [symbol] −log P1 [symbol] −0.0300 T+38.1 was satisfied. In this manner, a laminate comprising solid electrolyte layers, an active material layer and a current collector layer was obtained.

### (6) Production of Coin-Type Battery

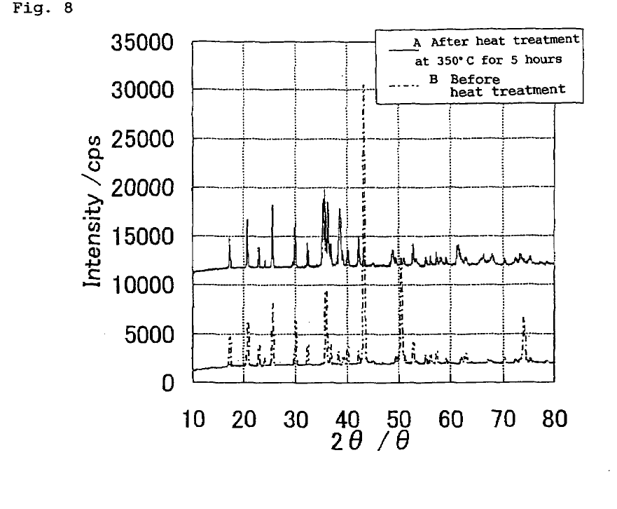

Using the obtained laminate, a coin-type battery 70 as shown in FIG. 7 was produced as follows.

Note that the following steps were performed in a dry air having a dew point of not greater than −50° C.

A negative electrode 73 was obtained by punching out a metal lithium foil having a thickness of 300 μm into a disc having a diameter of 12 mm. The obtained negative electrode 73 was placed on the inner bottom of a stainless steel battery case 71.

The solid electrolyte is reduced to TiO₂ when it directly contacts metal lithium. To avoid this, a Li ion conductive PEO-LiTFSI layer 74 comprising polyethylene oxide (PEO) and LiN(SO₂CF₃)₂ (LiTFSI) was formed on the negative electrode 73 in the following manner. PEO having an average molecular weight of 1000000 and LiTFSI were dissolved in dehydrated acetonitrile such that the molar ratio of the oxygen atoms of PEC to the lithium atoms of LiTFSI ([O]/[Li]) was 20/1. This solution was prepared to have a Li concentration of 0.1 mol/L.

On the negative electrode 73, the obtained solution was spin-coated at 2000 rpm, followed by vacuum-drying. Thereby, a PEO-LiTFSI layer 74 having a thickness of 5 μm was formed.

The laminate 78 comprising solid electrolyte layers 78a, a positive electrode active material layer 78b and a current collector layer 78c was placed on the PEO-LiTFSI layer 74 such that the PEO-LiTFSI layer 74 was in contact with the solid electrolyte layer 78a.

On the current collector layer 78c of the laminate 78 was placed a disc plate 75 having springs 76 welded thereto. On the disc plate 75 was placed a stainless steel sealing plate 72. The opening of the battery case 71 was sealed by crimping the opening edge of the battery case 71 onto the edge of the sealing plate 72 with a nylon gasket 77 therebetween. Thereby, a coin-type battery 70 was obtained.

### EXAMPLE 2

A battery was produced in the same manner as in EXAMPLE 1 except that the heating temperature in the fourth step was changed to 200° C.

### EXAMPLE 3

A battery was produced in the same manner as in EXAMPLE 1 except that the heating temperature in the fourth step was changed to 400° C.

### EXAMPLE 4

A battery was produced in the same manner as in EXAMPLE 1 except that, in the fourth step, a mixed gas (total pressure: 1 atm) comprising 10 vol % oxygen gas and 90 vol % argon gas was used as an oxidizing atmosphere instead of the air, and that the oxygen gas equilibrium partial pressure (P2) of the oxidizing atmosphere was set to 0.1 atm.

### EXAMPLE 5

A battery was produced in the same manner as in EXAMPLE 1 except that, in the fourth step, an oxidizing atmosphere comprising only an oxygen gas was used instead of the air, and that the oxygen gas equilibrium partial pressure (P2) was set to 1.0 atm.

### EXAMPLE 6

A battery was produced in the same manner as in EXAMPLE 1 except that, in the fifth step, the baking temperature was set to 700° C., and that the oxygen equilibrium partial pressure (P1) was set to 10^{-15.9} atm (−log P1:15.9). In other words, −0.0310 T+33.5 [symbol] −log P1 [symbol] −0.0300 T+38.1 was satisfied because it equals to 11.8 [symbol] 15.9 [symbol] 17.1. The oxygen equilibrium partial pressure (P1) was adjusted to 10^{-15.9} atm by setting the volume ratio of CO₂, H₂ and N₂ contained in the reduced gas to 4.86/0.00947/95.13053 (CO₂/H₂/N₂=4.86/0.00947/95.13053).

### EXAMPLE 7

A battery was produced in the same manner as in EXAMPLE 1 except that, in the fifth step, the baking temperature was set to 1000° C., and that the oxygen equilibrium partial pressure (P1) was set to 10^{-5.0} atm (−log P1:5.0). In other words, −0.0310 T+33.5 [symbol] −log P1 [symbol] −0.0300 T+38.1 was satisfied because it equals to 2.5 [symbol] 5.0 [symbol] 8.1. The oxygen equilibrium partial pressure (P1) was adjusted to 10^{-5.0} atm by setting the volume ratio of CO₂, H₂ and N₂ contained in the reduced gas to 4.86/0.00947/95.13053 (CO₂/H₂/N₂=4.86/0.00947/95.13053).

### EXAMPLE 8

A battery was produced in the same manner as in EXAMPLE 1 except that, in the fifth step, the baking temperature was set to 700° C., and that the oxygen equilibrium partial pressure (P1) was set to 10^{-11.8} atm (−log P1:11.8). In other words, −0.0310 T+33.5 [symbol] −log P1 [symbol] −0.0300 T+38.1 was satisfied because it equals to 11.8 [symbol] 11.8 [symbol] 17.1. The oxygen equilibrium partial pressure (P1) was adjusted to 10^{-11.8} atm by setting the volume ratio of CO₂, H₂ and N₂ contained in the reduced gas to 99.9982/0.0018/0 (CO₂/H₂/N₂=99.9982/0.0018/0).

### EXAMPLE 9

A battery was produced in the same manner as in EXAMPLE 1 except that, in the fifth step, the baking temperature was set to 700° C., and that the oxygen equilibrium partial pressure (P1) was set to 10^{-17.1} atm (−log P1:17.1). In other words, −0.0310 T+33.5 [symbol] −log P1 [symbol] −0.0300 T+38.1 was satisfied because it equals to 11.8 [symbol] 17.1 [symbol] 17.1. The oxygen equilibrium partial pressure (P1) was adjusted to 10^{-17.1} atm by setting the volume ratio of CO₂, H₂ and N₂ contained in the reduced gas to 1.2/0.01/98.79 (CO₂/H₂/N₂=1.2/0.01/98.79).

### EXAMPLE 10

A battery was produced in the same manner as in EXAMPLE 1 except that, in the fifth step, the baking temperature was set to 1000° C., and that the oxygen equilibrium partial pressure (P1) was set to 10^{-2.5} atm (−log P1:2.5). In other words, −0.0310 T+33.5 [symbol] −log P1 [symbol] −0.0300 T+38.1 was satisfied because it equals to 2.5 [symbol] 2.5 [symbol] 8.1. The oxygen equilibrium partial pressure (P1) was adjusted to 10^{-2.5} atm by setting the volume ratio of CO₂, H₂ and N₂ contained in the reduced gas to 99.9999/0.0001/0 (CO₂/H₂/N₂=99.9999/0.0001/0).

### EXAMPLE 11

A battery was produced in the same manner as in EXAMPLE 1 except that, in the fifth step, the baking temperature was set to 1000° C., and that the oxygen equilibrium partial pressure (P1) was set to 10^{-8.1} atm (−log P1:8.1). In other words, −0.0310 T+33.5 [symbol] −log P1 [symbol] −0.0300 T+38.1 was satisfied because it equals to 2.5 [symbol] 8.1 [symbol] 8.1. The oxygen equilibrium partial pressure (P1) was adjusted to 10^{-8.1} atm by setting the volume ratio of CO₂, H₂ and N₂ contained in the reduced gas to 8.0/0.01/81.99 (CO₂/H₂/N₂=8.0/0.01/81.99).

### COMPARATIVE EXAMPLE 1

A battery was produced in the same manner as in EXAMPLE 1 except that the heating temperature in the fourth step was changed to 150° C.

During the production of this battery, the second green sheet group did not sinter in the fifth step and it fractured. As such, the battery of COMPARATIVE EXAMPLE 1 was not obtained. The reason why the second green sheet group did not sinter is presumably because the binder was not removed sufficiently in the fourth step as the heating temperature was low, and thus the organic matter was carbonized.

### COMPARATIVE EXAMPLE 2

A battery was produced in the same manner as in EXAMPLE 1 except that the heating temperature in the fourth step was changed to 450° C.

### EXAMPLE 12

A battery was produced in the same manner as in EXAMPLE 1 except that, in the fourth step, a mixed gas (total pressure: 1 atm) comprising 5 vol % oxygen and 95 vol % argon gas was used as an oxidizing atmosphere instead of the air, and that the oxygen gas equilibrium partial pressure (P2) of the oxidizing atmosphere was set to 0.05 atm.

### EXAMPLE 13

A battery was produced in the same manner as in EXAMPLE 1 except that, in the fifth step, the baking temperature was set to 650° C., and that the oxygen equilibrium partial pressure (P1) was set to 10^{-18.8} atm (−log P1:18.8). In other words, −0.0310 T+33.5 [symbol] −log P1 [symbol] −0.0300 T+38.1 was not satisfied. The oxygen equilibrium partial pressure (P1) was adjusted to 10^{-18.8} atm by setting the volume ratio of CO₂, H₂ and N₂ contained in the reduced gas to 5/0.02/94.98 (CO₂/H₂/N₂=5/0.02/94.98).

### EXAMPLE 14

A battery was produced in the same manner as in EXAMPLE 1 except that, in the fifth step, the baking temperature was set to 1050° C., and that the oxygen equilibrium partial pressure (P1) was set to 10^{-7.2} atm (−log P1:7.2). In other words, −0.0310 T+33.5 [symbol] −log P1 [symbol] −0.0300 T+38.1 was not satisfied. The oxygen equilibrium partial pressure (P1) was adjusted to 10^{-7.2} atm by setting the volume ratio of CO₂, H₂ and N₂ contained in the reduced gas to 5/0.01/94.99 (CO₂/H₂/N₂=5/0.01/94.99).

### EXAMPLE 15

A battery was produced in the same manner as in EXAMPLE 1 except that, in the fifth step, the baking temperature was set to 700° C., and that the oxygen equilibrium partial pressure (P1) was set to 10^{-18.0} atm (−log P1:18.0). In other words, −0.0310 T+33.5 [symbol] −log P1 [symbol] −0.0300 T+38.1 was not satisfied. The oxygen equilibrium partial pressure (P1) was adjusted to 10^{-18.0} atm by setting the volume ratio of CO₂, H₂ and N₂ contained in the reduced gas to 0.45/0.01/99.54 (CO₂/H₂/N₂=0.45/0.01/99.54).

### EXAMPLE 16

A battery was produced in the same manner as in EXAMPLE 1 except that, in the fifth step, the baking temperature was set to 700° C., and that the oxygen equilibrium partial pressure (P1) was set to 10^{-11.7} atm (−log P1:11.7). In other words, −0.0310 T+33.5 [symbol] −log P1 [symbol] −0.0300 T+38.1 was not satisfied. The oxygen equilibrium partial pressure (P1) was adjusted to 10^{-11.7} atm by setting the volume ratio of CO₂, H₂ and N₂ contained in the reduced gas to 99.998/0.002/0 (CO₂/H₂/N₂=99.998/0.002/0).

### EXAMPLE 17

A battery was produced in the same manner as in EXAMPLE 1 except that, in the fifth step, the baking temperature was set to 1000° C., and that the oxygen equilibrium partial pressure (P1) was set to 10^{-9.0} atm (−log P1:9.0). In other words, −0.0310 T+33.5 [symbol] −log P1 [symbol] −0.0300 T+38.1 was not satisfied. The oxygen equilibrium partial pressure (P1) was adjusted to 10^{-9.0} atm by setting the volume ratio of CO₂, H₂ and N₂ contained in the reduced gas to 6.5/0.01/93.49 (CO₂/H₂/N₂=6.5/0.01/93.49).

### EXAMPLE 18

A battery was produced in the same manner as in EXAMPLE 1 except that, in the fifth step, the baking temperature was set to 1000° C., and that the oxygen equilibrium partial pressure (P1) was set to 10^{-2.4} atm (−log P1:2.4). In other words, −0.0310 T+33.5 [symbol] log P1 [symbol] −0.0300 T+38.1 was not satisfied. The oxygen equilibrium partial pressure (P1) was adjusted to 10^{-2.4} atm by setting the volume ratio of CO₂, H₂ and N₂ contained in the reduced gas to 99.9999/0.0001/0 (CO₂/H₂/N₂=99.9999/0.0001/0).

### EXAMPLE 19

A battery was produced in the same manner as in EXAMPLE 1 except that an iron powder having an average particle size of 1 μm was used as a current collector powder.

### [Evaluation]

After the production of each battery, the open circuit voltage was measured. Each battery was subjected to one charge/discharge cycle using a constant current of 1 μA between 3.0 to 5.0 V so as to obtain an initial discharge capacity. The results are shown in Table 1.

TABLE 1

| | Initial discharge capacity | Open circuit voltage |
|---|---|---|
| | (μAh) | (V) |
| EX. 1 | 12 | 4.6 |
| EX. 2 | 12 | 4.6 |
| EX. 3 | 12 | 4.6 |
| EX. 4 | 12 | 4.6 |
| EX. 5 | 12 | 4.6 |
| EX. 6 | 12 | 4.6 |
| EX. 7 | 12 | 4.6 |
| EX. 8 | 12 | 4.6 |
| EX. 9 | 12 | 4.6 |
| EX. 10 | 12 | 4.6 |
| EX. 11 | 12 | 4.6 |
| COMP. EX. 1 | — | — |
| COMP. EX. 2 | 0 | Unable to measure |
| EX. 12 | 3 | 2.0 |
| EX. 13 | 5 | 4.0 |
| EX. 14 | 1.5 | 2.0 |
| EX. 15 | 3 | 2.0 |
| EX. 16 | 1.5 | 5.5 |
| EX. 17 | 3 | 2.0 |
| EX. 18 | 1.5 | 5.5 |
| EX. 19 | 1.0 | 2.0 |

The battery of COMPARATIVE EXAMPLE 2 could not be charged. This is presumably because the heating temperature in the fourth step was high, an inactive by-product was produced at the interface between the current collector layer and the positive electrode active material layer, and the by-product inhibited the charge/discharge reaction of the battery.

In contrast, as can be seen from the results of EXAMPLEs 1 to 3, the batteries produced using a heating temperature in the fourth step of 200 to 400° C. exhibited excellent initial charge/discharge characteristics.

The laminate of EXAMPLE 1 was analyzed by X-ray diffraction (XRD) using CuKα radiation both before and after the fourth step. FIG. 8 shows the X-ray diffraction patterns before and after the heat treatment of the fourth step, in which A represents the X-ray diffraction pattern after the fourth step, and B represents the X-ray diffraction pattern before the fourth step. A comparison between the X-ray diffraction patterns before and after the fourth step indicates that peaks and patterns attributable to the positive electrode active material LiCoPO₄ were maintained. Referring in detail to the X-ray diffraction pattern after the fourth step, in addition to the peaks attributable to Cu, less intense peaks attributable to CuO were observed in 2θ=35 to 38°. Besides the peaks attributable to CuO, no other peaks were observed. This indicates that no inactive by-product was produced at the interface between the current collector and the positive electrode active material. It was also found that Cu (the current collector) was partially oxidized.

From the above, it can be seen that the heating temperature in the fourth step is preferably 200 to 400° C.

The results of EXAMPLEs 1, 4 and 5 show that the batteries produced using an oxidizing atmosphere having an oxygen gas equilibrium partial pressure (P2) of 0.1 to 1.0 atm in the fourth step exhibited excellent initial charge/discharge characteristics.

The battery of EXAMPLE 12, on the other hand, exhibited a low open circuit voltage of 2 V and an initial discharge capacity lower than that of the battery of EXAMPLE 1. This is presumably because in the production of the battery of EXAMPLE 12, the oxygen gas equilibrium partial pressure in the fourth step was low and therefore the binder and the plasticizer were not removed sufficiently. Thus, self-discharge occurred due to an internal short-circuit caused by the produced carbon, resulting in a low initial discharge capacity. From this, it can be seen that the oxidizing atmosphere in the fourth step preferably has an oxygen gas equilibrium partial pressure (P2) of 0.1 to 1.0 atm.

The results of EXAMPLEs 1, 6 and 7 show that the batteries produced using a baking temperature in the fifth step of 700 to 1000° C. exhibited excellent initial charge/discharge characteristics.

The battery of EXAMPLE 13, on the other hand, exhibited an initial discharge capacity lower than that of the battery of EXAMPLE 1. Presumably, this is because the baking temperature in the fifth step was low, and the baking was insufficient.

The battery of EXAMPLE 14 exhibited a low open circuit voltage of 2 V and an initial discharge capacity lower than that of the battery of EXAMPLE 1. In the battery of Example 14, the color of the sintered positive electrode active material (LiCoPO₄) layer became lighter than the dark purple, which was the color of the positive electrode active material layer in the battery of Example 1, and in the solid electrolyte layer of the battery of the Example 14, the color of the side portion thereof contacting the active material layer turned purplish. This is presumably because the baking temperature in the fifth step was high, the atoms forming LiCoPO₄ and the atoms forming the solid electrolyte were diffused, forming an inactive layer at the interface between the solid electrolyte and the active material, which resulted in a low capacity. From this, it can be seen that the baking temperature in the fifth step is preferably 700 to 1000° C.

The results of EXAMPLEs 6, 8 and 9 show that when the baking temperature in the fifth step was 700° C. and the oxygen equilibrium partial pressure (P1) of the low oxygen atmosphere satisfied 10^{-17.1} [symbol] P1 [symbol] 10^{-11.1} atm (i.e., −0.0310 T+33.5 [symbol] −log P1 [symbol] −0.0300 T+38.1 was satisfied), the obtained batteries exhibited further excellent initial charge/discharge characteristics.

The results of EXAMPLEs 7, 10 and 11 show that when the baking temperature in the fifth step was 1000° C. and the oxygen equilibrium partial pressure (P1) of the low oxygen atmosphere satisfied 10^{-8.1} [symbol] P1 [symbol] 10^{-2.5} atm (i.e., −0.0310 T+33.5 [symbol] −log P1 [symbol] −0.0300 T+38.1 was satisfied), the obtained batteries exhibited further excellent initial charge/discharge characteristics.

The batteries of EXAMPLEs 15 and 17, on the other hand, exhibited a low open circuit voltage of 2 V and an initial discharge capacity lower than that of the battery of EXAMPLE 1. This is presumably because the oxygen equilibrium partial pressure P1 of the low oxygen atmosphere in the fifth step was very low, and therefore the binder and the plasticizer were not removed sufficiently. As a result, self-discharge occurred due to the produced carbon.

The initial discharge capacities of the batteries of EXAMPLEs 16 and 18 were much lower than that of the battery of EXAMPLE 1. The laminates contained in the batteries of EXAMPLEs 16 and 18 were analyzed after the fourth step by XRD in the same manner as the laminate of the battery of EXAMPLE 1 was analyzed. Almost no peaks attributable to Cu were observed, and the intensity of the peaks attributable to CuO was higher. Further, most part of the current collector was oxidized. Even after the baking in a low oxygen atmosphere in the fifth step, the current collector remained oxidized. In other words, the current collector was not reduced sufficiently. For this reason, the batteries of EXAMPLEs 16 and 18 had a high open circuit voltage and a reduced capacity.

As can be seen from the results of EXAMPLE 1, the battery whose current collector contained Cu exhibited excellent initial charge/discharge characteristics. In contrast, the battery of EXAMPLE 19 whose current collector contained iron exhibited a lower open circuit voltage and a lower initial discharge capacity. The laminate contained in the battery of EXAMPLE 19 was analyzed by XRD in the same manner as the laminate contained in the battery of EXAMPLE 1 was analyzed. Almost no peaks attributable to Fe were observed, and the intensity of the peaks attributable to Fe₂O₃ was higher. Further, peaks attributable to a by-product believed to be produced by a reaction between the iron contained in the current collector and the active material were observed. From this, the reason why the capacity of the battery of EXAMPLE 19 decreased is considered to because most part of the current collector was oxidized and also the current collector and the positive electrode active material reacted to each other, forming a layer of by-product between the current collector layer and the positive electrode active material layer.

Although the examples given above employed a copper powder as a current collector powder, the effect of the present invention was similarly obtained even when the current collector powder comprised nickel, palladium, gold and/or platinum.

Likewise, although the examples given above employed LiCoPO₄ as a positive electrode active material, the effect of the present invention was similarly obtained even when LiMn_{0.5}Fe_{0.5}PO₄ and LiFePO₄ were used.

Likewise, although the examples given above employed Li_{1.3}Al_{0.3}Ti_{1.7}(PO₄)₃ as a solid electrolyte, the effect of the present invention was similarly obtained even when Li_{1.3}Y_{0.3}Ti_{1.7}(PO₄)₃ was used.

According to the present invention, a solid electrolyte layer, an active material layer and a current collector layer can be crystallized and the densities thereof can be increased. Moreover, a laminate having an electrochemically active interface between an active material and a solid electrolyte can be produced. The oxidation of current collector that usually occurs during the binder removal step (i.e., fourth step) in the production of a laminate type battery is also prevented. Accordingly, the production method of the present invention can provide a all solid state battery having a high capacity and less internal resistance.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A method for producing a solid state battery comprising a laminate including a solid electrolyte layer, an active material layer and a current collector layer, said method comprising the steps of:
(a) dispersing an active material powder in a solvent containing a binder and a plasticizer to obtain an active material slurry;
(b) dispersing a solid electrolyte powder in a solvent containing a binder and a plasticizer to obtain a solid electrolyte slurry;
(c) dispersing a current collector powder in a solvent containing a binder and a plasticizer to obtain a current collector slurry;
(d) forming an active material green sheet and a solid electrolyte green sheet using said active material slurry and said solid electrolyte slurry, respectively;
(e) laminating said solid electrolyte green sheet on one surface of said active material green sheet to form a first green sheet group, and forming a current collector green sheet layer on the other surface of said active material green sheet using said current collector slurry to form a second green sheet group;
(f) heating said second green sheet group at not less than 200° C. and not greater than 400° C. in an oxidizing atmosphere; and
(g) baking said second green sheet group having heated in said step (f) in a low oxygen atmosphere at a baking temperature higher than the heating temperature in said step (f) to obtain a laminate including a solid electrolyte layer, an active material layer and a current collector layer.

2. The method for producing a solid state battery in accordance with claim 1,
wherein said baking temperature in said step (g) is not less than 700° C. and not greater than 1000° C.

3. The method for producing a solid state battery in accordance with claim 1,
wherein said current collector powder comprises at least one selected from the group consisting of copper, nickel, palladium, gold and platinum.

4. The method for producing a solid state battery in accordance with claim 1,
wherein in said step (g), an oxygen equilibrium partial pressure (atm) of said low oxygen atmosphere represented by P1 and said baking temperature (° C.) represented by T satisfies −0.0310 T+33.5 [symbol] −log P1 [symbol] −0.0300 T+38.1.

5. The method for producing a solid state battery in accordance with claim 1,
wherein in said step (f), said oxidizing atmosphere contains an oxygen gas, and
said oxidizing atmosphere has an oxygen gas equilibrium partial pressure (P2) of not less than 0.1 atm and not greater than 1.0 atm.

6. The method for producing a solid state battery in accordance with claim 1,
wherein said step (e) further comprises cutting said first green sheet group or said second green sheet group into a specified size.

7. The method for producing a solid state battery in accordance with claim 1,
wherein said method further comprises, after said step (g), forming an external electrode connected to said current collector layer on one surface of said laminate.

8. The method for producing a solid state battery in accordance with claim 1,
wherein said active material powder comprises a first phosphoric acid compound capable of absorbing and releasing lithium ions, and
said solid electrolyte powder comprises a second phosphoric acid compound having lithium ion conductivity.

9. The method for producing a solid state battery in accordance with claim 8,
wherein said first phosphoric acid compound is represented by the following formula (1):
LiMPO₄ (1)
where M represents at least one selected from the group consisting of Mn, Fe, Co and Ni.

10. The method for producing a solid state battery in accordance with claim 8,
wherein said second phosphoric acid compound is represented by the following formula (2):
Li_{1+X}M^{III}_{X}Ti^{IV}_{2-X}(PO₄) (2)
where M^{III} represents at least one selected from the group consisting of Al, Y, Ga, In and La, and 0 [symbol] X [symbol] 0.6.
